(19) United States
(12) Patent Application Publication
(10) Pub. No.: US 2014/0025569 A1
(43) Pub. Date: Jan. 23, 2014

(54) PRODUCT LEASE WITH PAYMENT REDUCTION OR SUSPENSION PER MONTH BASED ON USE

(71) Applicant: Brent R. Jones, Sherwood, OR (US)

(72) Inventor: Brent R. Jones, Sherwood, OR (US)

(73) Assignee: XEROX CORPORATION, Norwalk, CT (US)

(21) Appl. No.: 13/551,721

(22) Filed: Jul. 18, 2012

(51) Int. Cl. G06Q 20/22

(52) U.S. Cl. 705/40

(57) ABSTRACT

A method of providing an electromechanical device to a user includes leasing use of the device to the user for a lease term and in exchange for a dynamic fee. The method further includes determining the fee on a periodic basis during the lease term. The process of the determining includes determining an amount of a resource consumed by the device during a select period. The determining further includes computing the fee in response to the amount. The determining also includes automatically adjusting the fee in response to a change in the amount between the select period and one of a preceding period and an initial rate. The method includes outputting the fee for each period during the lease term.

### BACKGROUND

The present disclosure relates to a method and a system for leasing use of an electromechanical device for a fixed lease term at a dynamic lease rate. The disclosure finds application in printer device use and management. However, it is appreciated that the present exemplary embodiments are also amendable to other like applications.

For business and other environments that rely on a printer device, such as a multifunction device, for performing daily operations, the business can obtain access to the printer device in one of several ways. In a first traditional approach, the business can purchase the printer device up front and then purchase consumables and resources, such as paper and toner/ink cartridges, from a distributor-of-choice on an as-needed basis. In a second traditional approach, the business can lease the printer device from a lessor and continue to purchase the consumables and resources from the lessor. The lessor can replenish a consumable or resource as it runs low. Alternatively, the lessor can replenish consumables and resources in specified amounts, based on forecasts, which are agreed upon by the parties when the lease is entered. In this scenario, the business may be required to purchase more resources and consumables than it later uses.

One method 10 describing a traditional lease option is shown in the flow-chart of FIG. 1. The method starts at S12. The parties enter an agreement, which establishes a relationship between a select printer device and a user (lessee) for a fixed lease term at S14. The lease term is generally divided into a number of periods. A period starts at S16. The lessor charges the user a fixed rate for the period according to the terms of the lease at S18. The lessor acquires payment for the period at S20. If the current period is not the last period of the lease term (NO at S22), the method returns to S16 and repeats for the next period. If the current period is the last period of the lease term (YES at S22), the method ends at S24.

One aspect of the traditional lease option is that the lease rate is fixed regardless of the amount of consumables that are consumed by the user. In other words, the user receives no cost break when it consumes a large number of consumables or a low amount of resources during a period. One problem associated with this approach is that the user cannot absorb the costs of slow periods during busy periods. During busy periods, the user can be paying for both a large number of consumables/resources and the fixed lease rate. However, during slower periods, the user is still required to pay the fixed lease rate, which may seem high compared to the user's needs for that period. There is no advantage provided to the user for increasing or decreasing its usage of the printer device in any one period.

A system and a method for providing a device lease to a user are therefore desired to include a first rate for slower periods and a second rate for busier periods. It is desirable that the first rate be a fixed rate, which is lower than a standard lease rate in exchange for the user entering a lease including a dynamic second rate. It is desirable that the second rate be a dynamic rate, which reduces the lease rate for a period as a result of (i.e., in exchange for) an increase in consumable and resource purchases. It is desirable that neither the lessor nor lessee absorb a loss in one period that can be caused in a different period.

### BRIEF DESCRIPTION

One embodiment of the disclosure relates to a method of providing an electromechanical device to a user. The method includes leasing use of the device to the user for a lease term and in exchange for a dynamic fee. The method further includes determining the fee on a periodic basis during the lease term. The process of the determining includes determining an amount of a resource consumed by the device during a select period. The determining further includes computing the fee in response to the amount. The determining also includes automatically adjusting the fee in response to a change in the amount between the select period and one of a preceding period and an initial rate. The method includes outputting the fee for each period during the lease term.

Another embodiment of the disclosure relates to a system for providing an electromechanical device to a user. The system includes a lease module that is adapted to associate the device with the user. The lease module is further adapted to selectively provide operation of the device to the user and acquire a dynamic fee from the user for a lease term. The system includes a dynamic fee determination module that is adapted to determine the fee on a periodic basis during the lease term. The determination module is further adapted to determine an amount of a resource consumed by the device during a select period. The determination module is adapted to compute the fee in response to the amount. The determination module is adapted to automatically adjust the fee in response to a change in the amount. The system includes a processor adapted to implement the modules. The system also includes an output device adapted to provide the fee for each period during the lease term.

### BRIEF DESCRIPTION OF THE DRAWINGS

FIG. 1 is a flow-chart describing a method for leasing a printer device known in the PRIOR ART.

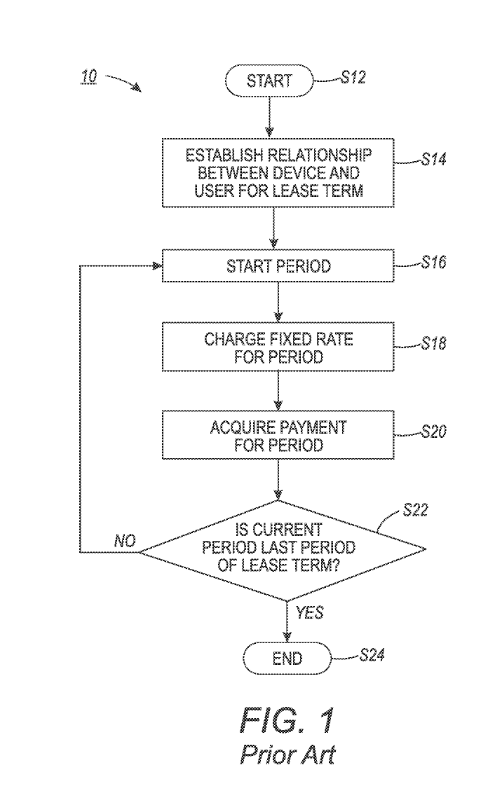

FIG. 2 is a schematic illustration of a lease calculation system in one exemplary embodiment.

FIG. 3 is a flow-chart describing a method of providing a printer device to a user according to one exemplary embodiment.

### DETAILED DESCRIPTION

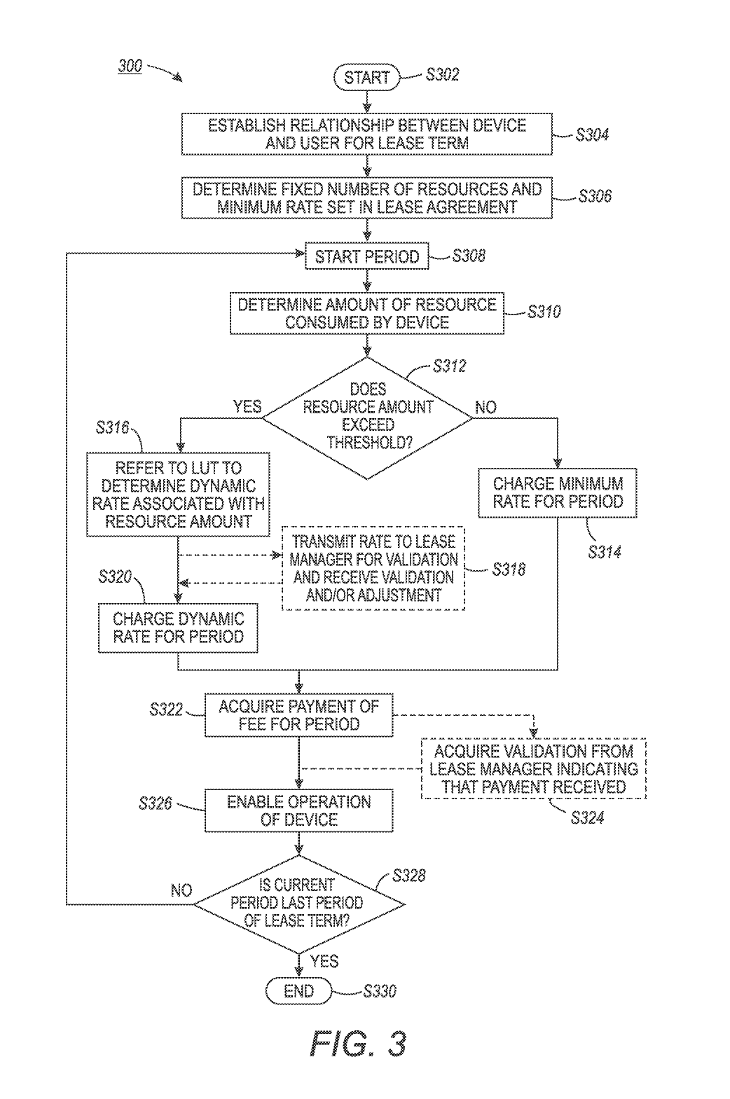

The present disclosure relates to a method and a system for calculating a dynamic lease rate for use of a printer device. FIG. 3 is a functional block diagram of a lease calculation system 100 in one exemplary embodiment. The system 100 may include a lease rate determination system 102, hosted by a computing device 104, such as a server computer at a service provider site, a printer device 106, and a lease manager 108, which are linked together by communication links 110, referred to herein as a network. These components are described in greater detail below.

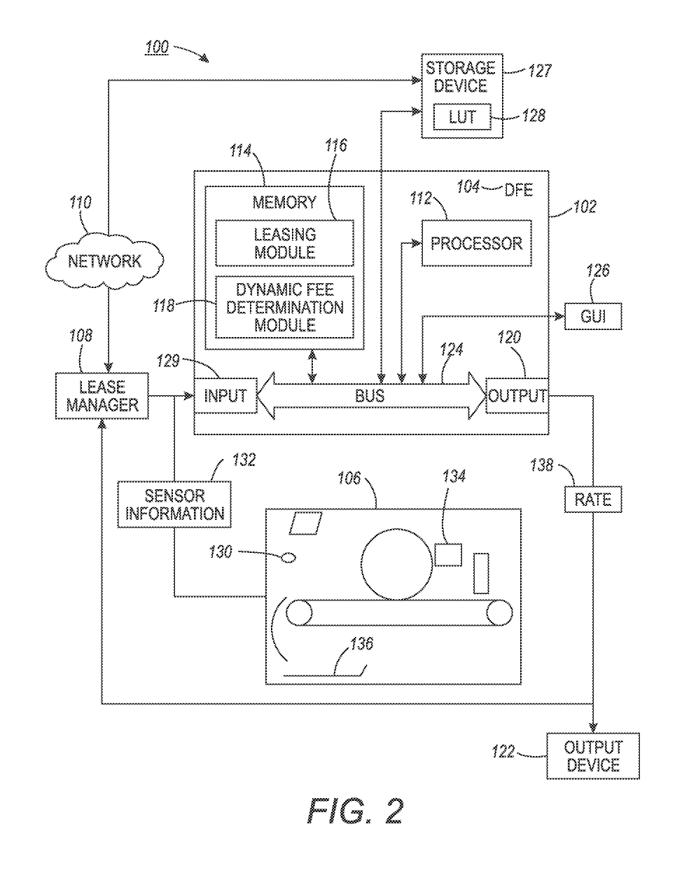

The lease calculation system 100 illustrated in FIG. 2 includes a processor 112, which controls the overall operation of the routing system 100 by execution of processing instructions, which are stored in memory 114 connected to the processor 112.

The dynamic lease rate operation disclosed herein is performed by the processor 112 according to the instructions stored in the memory 114. In particular, the memory 114 stores leasing module 116, which associates a select printer device with a user, and a dynamic fee determination module 118, which determines a dynamic lease rate for each period during the lease.

The illustrated leasing module 116 registers a relationship between a user and a particular printer device for the user's (exclusive) access to and use of the device. In one embodiment, the lease manager 108 can provide the lease rate determination system 102 with the user and printer device information, which is more specifically communicated to the leasing module 116. The leasing module 116 selectively provides operation of the printer device to the user and acquires a dynamic fee from the user for each period of the lease term.

The dynamic fee determination module 118 determines the lease rate on a periodic basis during the lease term. More specifically, the dynamic fee determination module 118 determines an amount of a resource consumed by the printer device 106 during a select period. The module 118 computes a fee for the amount using an LUT (Look-Up Table) or algorithm. The module 118 automatically adjusts the fee in response to a change in the amount.

The lease rate determination system 102 also includes one or more communication interfaces (I/0), such as network interfaces 120 for communicating with external devices, such as a customer side computer (e.g., output device 122) or server and/or a lease manager 108. The various hardware components 112, 114, 120 of the lease rate determination device 102 may all be connected by a bus 124.

With continued reference to FIG. 2, the lease rate determination device 102 is communicatively linked to a user interface device (GUI) 126 via a wired and/or wireless link. In various embodiments, the user interface device 126 may include one or more of a display device, for displaying information to users, such as a calculated lease rate to a human operator for review, and a user input device, such as a keyboard or touch or writable screen, for inputting instructions and/or receiving a validation or correction provided by the operator, and/or a cursor control device, such as a mouse, trackball, or the like, for communicating user input information and command selections to the processor 112. Specifically, the user interface device 126 includes at least one of an input device and an output device, both of which include hardware, and which can be communicatively linked with the server via wired and/or wireless link(s).

With continued reference to FIG. 2, the lease calculation system 100 includes a storage device 127 that is part of or in communication with the determination device 102. In one embodiment, the calculation system 100 can be in communication with a server (not shown) that hosts storage device 127, for storing a look-up table (LUT) 128 that includes prearranged fee schedules with thresholds so that lease payment amounts can be determined at the determination system 102.

The determination system 102 of the lease calculation system 100 can be in communication with the lease manager 108, which can include a lease system, agent, or manager that validates compliance of the lease payment. The lease manager can include a monitored or an automated system.

The determination device 102 can also be linked to at least one printer device 106. An exemplary printer 106 may include a marking engine, which applies marking medium, such as ink or toner, to a substrate, such as paper, using, for example, a laser, inkjet, thermal, or other transfer process. The printer renders images on print media, such as paper, and can be a copier, image printer, bookmaking machine, facsimile machine, or a multifunction machine (which includes one or more functions such as scanning, printing, archiving, emailing, and faxing). In other embodiments, the printer device 106 may be any other type of electromechanical device that can be leased.

In one embodiment, the printer device 106 can contain a system outboard that includes a handshake on thresholds and fees. In this manner, the outboard can be in communication with the dynamic fee determination module 118 of the determination system 102.

Generally, the printer device 106 includes at least one sensor 130 that senses and relays at least one of consumable and resource level information 132 to the determination system 102. The sensor 130 can monitor, for example, a level of ink/toner cartridge 134 and/or the amount of paper supplied in a tray 136 and/or the number of images printed and/or consumables replaced. Each printer device 106 can include an alert generator (not shown), which outputs an alert when it determines a need for replacement consumables.

The determination system 102 can also be in communication with at least one external (output) device, such as, for example, a user device 122. The determination device 102 can transmit the calculated lease rate 138 for each period to the output device 122 for informing the user of the periodic rate.

The memory 114 may represent any type of tangible computer readable medium such as random access memory (RAM), read only memory (ROM), magnetic disk or tape, optical disk, flash memory, or holographic memory. In one embodiment, the memory 114 may comprise a combination of random access memory and read only memory. The digital processor 112 can be variously embodied, such as by a single-core processor, a dual-core processor (or more generally by a multiple-core processor), a digital processor and cooperating math coprocessor, a digital controller, or the like. The digital processor 112, in addition to controlling the operation of the respective determination system 102, executes instructions stored in memory 114 for performing the parts of the method outlined below.

The software modules as used herein, are intended to encompass any collection or set of instructions executable by the determination system 102 so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on the server or other location to perform certain functions.

The communication interfaces 120 may include, for example, a modem, a router, a cable, and and/or Ethernet port, etc.

FIG. 3 shows a flow-chart describing a method 300 for providing access of a printer device to a user according to one exemplary embodiment. The method starts at S302. The leasing module 116 establishes a relationship between a printer device and a user for a lease term at S304. In one embodiment, the module 116 can register the print device and the user with the system 100 after receiving, as inputs at the user interface, user and device identification information. Alternatively, the system 100 can acquire the identification information as automatic transmissions from the user and printer devices 122, 106. In another embodiment, the module 116 can associate the printer device 106 and the user in response to input received from a lease manager 108.

The leasing module 116 further acquires lease terms that are agreed upon by the user at S306. These lease terms can include, for example, prearranged fee schedules and threshold amounts. The fee schedules can be based on a set duration(s) for a period of the lease term. A periodic basis can include a week, a month, a quarter, a season, a year, and a combination of the above. There is no limitation made herein to the duration set for a period and to whether each period is of equal and/or unequal duration. For example, the duration set for a period of the lease term may be shorter during seasons when there is increased need for the printer device 106 and, similarly, longer for seasons of decreased need for the printer device 106.

The threshold amounts relate to at least one of the amount of resource and the amount of consumable that is used by the printer device and requires replacement. These amounts can be based on forecasts and user needs, which can be variable during the different periods of a lease term.

One lease term that can be acquired at S306 includes a fixed number of resources that is set as a first threshold for determining whether a minimum rate or a dynamic rate applies for a period. This fixed number of resources refers to a value representing a number/amount of resource that is compared to a corresponding number consumed during a period in consideration. In another embodiment, the fixed number can refer to the value that is compared to a corresponding number/amount of replacement consumables/resources that are actually ordered from the lessor during the period.

Another lease term that can be acquired by the leasing module 116 includes a minimum rate that can be set for periods when the determined number of consumables/resources does not meet or exceed the first threshold. Generally, this rate is agreed upon by the parties before the lease is entered and is lower than a standard lease rate.

Additional lease terms that can be acquired by the leasing module 116 can include thresholds that enable lease payment amounts to be determined based on how much the printer device is used during a period. In other words, the lease rate can decrease per unit(s) of resource consumed. The parties to the lease can set dynamic rates that are each based on the varying amounts of resources that can be consumed by the printer device during a current period.

The terms can be transmitted to the leasing module 116 from a user device 122 or the manager device 108. Alternatively, the terms can be provided to the determination system 102 using the user interface 126.

Continuing with FIG. 3, a period during the lease term starts at S308. The dynamic fee determination module 118 determines an amount of resource consumed by the printer device 106 at S310. In one embodiment, the module 118 can acquire the amount as a consumable/resource level 132 that is transmitted from a sensor 130 monitoring the printer device 106. In another embodiment, the module 118 can receive sensor information transmitted from the printer device 106 and use the information to compute the amount based on an LUT or on algorithms. In another embodiment, the determination module 118 can count the number of units that are consumed based on acquired input. In one example for a resource that is print media, a sensor can count a number of images that are rendered by the printer device 106 and the module 118 can determine the amount of print media consumed using the count information.

Next, the dynamic fee determination module 118 determines whether the resource amount meets or exceeds a threshold at S312. More specifically, the module 118 determines whether the resource amount meets the minimum threshold that is set at S306. Generally, the dynamic fee is at a minimum rate for a first number N₁ of resources consumed by the printer device 106 and a dynamic rate for a second number N₂ of resources consumed by the printer device. The first number N₁ is below the minimum threshold rate and the second number N₂ meets and exceeds the minimum threshold rate. Therefore, the first number N₁ is less than the second number N₂.

For a resource amount that does not meet or exceed the minimum threshold (NO at S312), the module 118 determines that the lease rate for the current period is the minimum (i.e., fixed) rate determined at S306. The system 102 can output the minimum rate to an external device at S314. More specifically, the system 102 can charge the minimum rate for the current period by displaying the rate at the user interface 126, transmitting the rate to the output device 122, and/or by transmitting the rate to a lease manager 108.

For a resource amount that meets and exceeds the minimum threshold (YES at S312), the dynamic fee determination module 118 computes a dynamic lease rate for the current period at S316. In one embodiment, the module 118 can refer to a LUT, which maps a rate with an associated resource amount. In another embodiment, a handshake on the thresholds and fees is made with a system outboard of the printer device 106. The printer device is in at least periodic communication with the determination system 102, and transmits the computed rate to the system 102.

Generally, one aspect of the present method is to provide the user with cost savings while continuing to generate at least minimum fee amounts for the lessor when the amount varies (i.e., increases or decreases) from the amount corresponding to the minimum threshold rate. Accordingly, for an increase in the amount of resource that is consumed during a select period being beyond one of the predetermined thresholds, the cost per resource is lowered for the amount of the resource that is consumed beyond the (e.g., closest) threshold). Similarly, for a decrease in the amount of the resource consumed during the period being below a minimum threshold, the lease rate is maintained at the minimum, predetermined rate based on the minimum number of resources that are fixed at S306.

Optionally, the dynamic fee determination module 118 can provide the computed lease rate for the current period to the lease manager at S318. The lease manager can communicate with the LUT to validate the rate or to (override the rate and) adjust the rate.

With continued reference to FIG. 3, the system 102 can output the dynamic rate to an external device at S320. More specifically, the system 102 can charge the dynamic rate for the current period by displaying the rate at the user interface 126, transmitting the rate to the output device 122, and/or by transmitting the rate to a lease manager 108.

In the embodiment described for FIG. 3, the dynamic fee determination module 118 determines the periodic rate/fee S310, S312, S316 during the current period and outputs the fee at an end of the current period at S314, S320. In another embodiment, the dynamic fee determination module 118 can determine the periodic rate/fee for a preceding period and output the computed rate at a beginning of a current period. There is no limitation made herein to the period used to compute the rate and the period when the rate is charged.

Continuing with FIG. 3, the lease calculation system 100 acquires payment of the periodic fee at S322. In one embodiment, the system 100 can optionally acquire validation from the lease manager 108 indicating that the fee has been received for the current period at S324. In another embodiment, the system 100 can receive a payment that is automatically or manually transmitted from the user device 122. In response to the payment being acquired by the system 100, the system enables continued operation of the printer device 106 at S326 for the next period of the lease term. Based on the terms of the lease agreement, the system 100 can suspend operation, continue operation, or cancel the lease in response to deficient payment.

The fee calculation system 100 determines whether the current period is the last period of the lease term at S328. In response to the current period not being the last period of the lease term (NO at S328), the process returns to S308 and repeats for the next period of the lease term. In response to the current period being the last period (YES at S328), the method ends at S330.

One aspect of the disclosure is that the user is charged a minimum rate for periods when it is not substantially maximizing use of the printer device 106 or, in other words, using a generally low number N₁ of resources. However, the minimum rate is less than a fixed rate in a competing standard lease option and the number N₁ of resources required for meeting the dynamic threshold is less than the number of resources that the standard lease option is based from. Because the dynamic rate varies depending on the amount of resource consumed, the lessor is able to absorb the cost in the lower usage months because of increased printer usage in other months. Another aspect of the disclosure is that the user is paying a dynamic rate that decreases per unit resource as the numbers of replacement resources that are needed increases. In this manner, the lessor is generating substantially enough income from the consumables/resources that it can charge less on the rate during busier months. This dynamic rate also provides incentives to the user to increase its volume of output and, therefore, use of the printer device 106.

Although the control method 300 is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 100, wherein the disclosure is not limited to the specific applications and embodiments illustrated and described herein.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method of providing an electromechanical device to a user, the method comprising:
using a processor, establishing a relationship between the device and the user for a lease term and in exchange for a dynamic ease rate, wherein the relationship establishes that the user leases the device and purchases consumable resources from a lessor;
determining the lease rate on a periodic basis during the lease term, the determining including:
determining an amount of a consumable resource consumed by the device during a select period,
computing the lease rate in response to the amount, and
automatically adjusting the lease rate for the select period during the lease term in response to a change in the amount between the select period and one of a preceding period and an initial rate; and
outputting the lease rate for each period during the lease term.

2. The method of claim 1 further comprising:
in response to an increase in the amount of the resource consumed during the select period being beyond a minimum threshold, calculating the lease rate based on a lowered cost per resource for an amount of the resource consumed beyond the threshold.

3. The method of claim 1 further comprising:
in response to a decrease in the amount of the resource consumed during the period being below a minimum threshold, maintaining a lease rate at a minimum predetermined rate based on a fixed number N of resources.

4. The method of claim 1, wherein the dynamic lease rate is at a minimum rate for a first number N₁ of resources consumed by the device and a dynamic rate for a second number N₂ resources consumed by the device, wherein the second number N₂ is greater than the first number N₁.

5. The method of claim 4, wherein the minimum rate is less than a fixed rate of a competing standard lease option and the first number N₁ of resources is less than a number of minimum resources required in the standard lease option.

6. The method of claim 1, wherein the determining the lease rate is performed during a current period and the outputting the lease rate is provided at an end of the current period.

7. The method of claim 1, wherein the determining the lease rate is performed during a preceding period and the outputting the lease rate is provided at a beginning of the current period.

8. The method of claim 1, wherein the electromechanical device includes a printer machine.

9. The method of claim 8, wherein the resource is print media and the amount is based on a number of images rendered by the printer machine.

10. The method of claim 1, wherein the periodic basis is selected from a group consisting of:
a week;
a month;
a quarter;
a season;
a year; and,
a combination of the above.

11. A computer program product comprising tangible media which encodes instructions for performing a method, comprising:
using a processor, establishing a relationship between the device and the user for a lease term and in exchange for a dynamic lease rate, wherein the relationship establishes that the user leases the device and purchases consumable resources from a lessor;
determining an amount of a consumable resource consumed by the device during a select period;
in response to the amount being above a threshold, calculating a dynamic lease rate based on the amount;
in response to the amount being below the threshold, maintaining a predetermined lease rate for a fixed number of resources; and,
outputting the lease rate for the select period during the lease term; and,
repeating the method for each remaining period.

12. (canceled)

13. A system for providing an electromechanical device to a user, the system comprising:
an electromechanical device comprising memory for storing modules including:
a lease module for associating the device with the user, the lease module adapted to selectively provide operation of the device to the user and acquire a dynamic lease rate from the user for a lease term;
a dynamic lease rate determination module for determining the lease rate on a periodic basis during the lease term
determining an amount of a resource consumed by the device during a select period,
computing the lease rate in response to the amount, and
automatically adjusting the lease rate in response to a change in the amount; and,
a processor adapted to implement the modules; and,
an output device adapted to provide the lease rate for each period during the lease term.

14. The system according to claim 13, wherein the determination module is further adapted to:
in response to an increase in the amount of the resource consumed during the select period being beyond a minimum threshold, calculating the lease rate based on a lowered cost per the resource for an amount of the resource consumed beyond the threshold.

15. The system according to claim 13, wherein the determination module is further adapted to:
in response to a decrease in the amount of the resource consumed during the period being below a minimum threshold, maintaining a lease rate at a minimum rate based on a fixed number N of resources.

16. The system according to claim 13, wherein the determination module is further adapted to:
compute the dynamic lease rate at a minimum rate for a first number N₁ of resources consumed by the device and at a dynamic rate for a second number N₂ resources by the device, wherein the second number N₂ is greater than the first number N₁.

17. The system according to claim 13, wherein the determination module is further adapted to:
determine the lease rate during a current period; and,
transmit the lease rate to at least one of a manager and the output device at an end of the current period.

18. The system according to claim 13, wherein the determination module is further adapted to:
determine the lease rate during a preceding period; and,
transmit the lease rate to at least one of a manager and the output device at a beginning of the current period.

19. The system according to claim 13, wherein the electromechanical device includes a printer machine.

20. The system according to claim 13, wherein the periodic basis is selected from a group consisting of:
a week;
a month;
a quarter;
a season;
a year; and,
a combination of the above.
